(19) United States
(12) Patent Application Publication
(10) Pub. No.: US 2018/0218364 A1
(43) Pub. Date: Aug. 2, 2018

(54) MANAGING DISTRIBUTED CONTENT USING LAYERED PERMISSIONS

(71) Applicant: Walmart Apollo, LLC, Bentonville, AR (US)

(72) Inventors: Robert Cantrell, Herndon, VA (US); Donald Ray High, Noel, MO (US); John Jeremiah O'Brien, V, Farmington, AR (US); Brian McHale, Oldham (GB); Todd Mattingly, Bentonville, AR (US); Joseph Jurich, JR., Molino, FL (US)

(21) Appl. No.: 15/881,709

(22) Filed: Jan. 26, 2018

Related U.S. Application Data
(60) Provisional application No. 62/451,648, filed on Jan. 27, 2017.

(51) Int. Cl. G06Q 20/38; G06Q 20/36; G06F 21/10; H04L 29/08

(52) U.S. Cl. CPC G06Q 20/3829; G06Q 20/36; G06Q 2220/00; H04L 67/10; G06F 21/10

(57) ABSTRACT

Examples of the disclosure provide systems and methods for managing distributed content. A computing system constructs a permission list including a first layer defining first privileges and a second layer defining second privileges. The permission list is associated with a first transaction regarding the distributed content between a first user and a second user such that the first layer is associated with the first user and the second layer is associated with the second user. A request associated with the first transaction is transmitted to a network including one or more nodes, and a notification associated with a validation of the first transaction is received from the network. If a parameter is satisfied, a trigger is executed to modify the second layer. A notification associated with a validation of a second transaction regarding the distributed content between the first user and the second user is received.

### BACKGROUND

Content may be distributed to a broad range of consumers, including both trusted and untrusted users. To distribute content in a secure, transparent manner, at least some content providers may electronically track and verify one or more transactions using blockchain technology. After distributing the content, however, at least some content providers have limited control over the content. For example, a consumer may copy and/or redistribute the content to one or more other users. Moreover, content providers using blockchain technology to electronically track and verify transactions may have difficulty reversing a transaction in a blockchain ledger.

### SUMMARY

Examples of the disclosure provide a computer-implemented method for managing distributed content. The computer-implemented method includes receiving a transaction request associated with a first transfer of an asset associated with the distributed content between a first user and a second user, and associating a permission list including a first layer and a second layer with the asset. The first layer includes a first identifier associated with the first user, first role data defining a first set of privileges associated with the first user, and event condition action data defining a trigger configured to execute on condition that a predetermined parameter is satisfied. The second layer includes a second identifier associated with the second user and second role data defining a second set of privileges associated with the second user. The computer-implemented method further includes communicating with one or more nodes in a network to validate a first transaction associated with the first transfer of the asset, and, upon identification of the predetermined parameter being satisfied, executing the trigger to perform one or more triggered actions. The triggered actions include communicating with the nodes in the network to validate a second transaction associated with a second transfer of the asset between the first user and the second user. The second transfer is associated with a modification of the second layer.

In another aspect, a computing system is provided for managing distributed content. The computing system includes a memory device storing data associated with the content and computer-executable instructions, and a processor configured to execute the computer-executable instructions to construct a permission list including a first layer and a second layer. The first layer defines a first set of privileges and a set of triggers. A trigger of the set of triggers is configured to modify the second layer on condition that a predetermined parameter is satisfied. The second layer defines a second set of privileges. The processor is configured to further execute the computer-executable instructions to associate the permission list with a first transaction regarding the distributed content between a first user and a second user such that the first layer is associated with the first user and the second layer is associated with the second user, identify a network including one or more nodes, transmit a first request associated with the first transaction, receive a first notification associated with a first validation that is associated with the first transaction, and, on condition that the predetermined parameter is satisfied, receive a second notification associated with a second validation that is associated with a second transaction regarding the distributed content between the first user and the second user. The second transaction is associated with an execution of the trigger.

In yet another aspect, one or more computer storage media embodied with computer-executable instructions are provided. The computer storage media include a client component, a consensus component, a manager component, and a trigger component. The client component receives a transaction request associated with a first transfer of an asset between a first user and a second user, and transmits a response to the transaction request. The consensus component transmits a local instance of the transaction request to one or more nodes in a network, receives one or more remote instances of the transaction request from the nodes in the network, and implements a consensus protocol to validate a transaction associated with the first transfer of the asset. The manager component associates a first permission layer with the first user such that the first user is associated with a first set of privileges, and associates a second permission layer with the second user such that the second user is associated with a second set of privileges. The trigger component monitors the asset, the first user, and/or the second user and, if a triggering event is detected, determines whether a second transfer of the asset between the first user and the second user is to be performed for modifying the second permission layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example computing device for managing distributed content using a computing device.

FIG. 2 is a block diagram illustrating an example content management environment that may be used with a computing device, such as the computing device shown in FIG. 1.

FIG. 3 is a block diagram illustrating an example content management environment operating as a cloud-based service using a centralized network.

FIG. 4 is a block diagram illustrating an example content management environment operating as a cloud-based service using a distributed network.

FIG. 5 is a block diagram illustrating example layers for managing content using blockchain technology.

FIG. 6 is a flowchart illustrating an example method for managing content using a computing device, such as the computing device shown in FIG. 1.

FIG. 7 is a sequence diagram illustrating an example method for managing content using a distributed network, such as the distributed network shown in FIG. 4.

FIG. 8 is a block diagram illustrating an example operating environment for a computing device, such as the computing device shown in FIG. 1.

Corresponding reference characters indicate corresponding parts throughout the drawings.

### DETAILED DESCRIPTION

Referring to the figures, examples of the disclosure enable distributed content to be managed. Blockchain technology, for example, may be used to facilitate the distribution and management of the content. A blockchain may be used as a public ledger including an ordered and timestamped record of transactions. The examples described herein enable one or more transactions associated with distributed content to be administered or managed in accordance with one or more claims or privileges associated with the content.

Aspects of the disclosure provide for a computing device that performs one or more operations in an environment including a plurality of devices coupled to each other via a network (e.g., a local area network (LAN), a wide area network (WAN), the Internet). For example, a computing device may communicate with one or more other computing devices, including one or more client devices, to facilitate content distribution and/or management. In some embodiments, the computing device analyzes data associated with a plurality of user devices to facilitate a transaction between a plurality of users associated with the user devices.

The systems and processes described herein may be implemented using computer programming or engineering techniques including computer software, firmware, hardware or a combination or subset thereof. Aspects of the disclosure improve processor security, data integrity, data storage security, data security in networked devices, data transmission security, and/or communication between computing systems by controlling communications and managing access to various accounts using a public key cryptographic system and/or by verifying and validating transaction data using a proof-of-work protocol and a consensus protocol. Additionally, some aspects may improve user experience, user efficiency, and/or user interaction performance by facilitating transactions in an effective and efficient manner. Moreover, some aspects may increase processor speed, improve operating system resource allocation, and/or reducing error rate by automating the processing of large volumes of data.

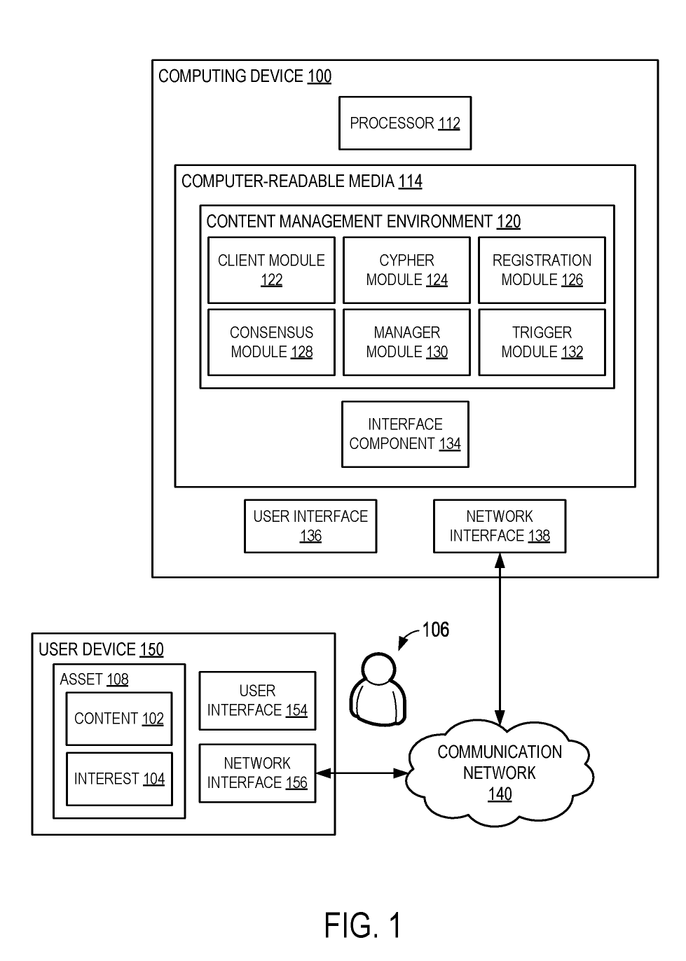

FIG. 1 is a block diagram illustrating an example computing device 100 for managing distributed content. The computing device 100 represents a system configured to facilitate distribution and/or management of content 102, such as an intangible good, data associated with a tangible good, and/or data associated with a service. Intangible goods may include, for example, digital media, software, applications, virtual goods, electronic tickets, electronically-traded financial instruments, access rights, control rights, and the like.

The content 102 may be associated with one or more interests 104. An interest 104 includes data associated with a claim or privilege to the content 102 and/or a permission to exercise a privilege from the claim (e.g., a license). The interest 104 may be used to control or manage the content 102 and/or one or more uses of the content 102. For example, the interest 104 may allow a user 106 to access, use, modify, copy, and/or distribute the content 102. For another example, the interest 104 may allow the user 106 to allow one or more other users to access, use, modify, copy, and/or distribute the content 102. For yet another example, the interest 104 may allow the user 106 to disallow one or more other users from accessing, using, modifying, copying, and/or distributing the content 102. In some examples, the interest 104 allows the user 106 to control or manage the interest 104 itself and/or one or more uses of the interest 104. For example, the interest 104 may allow the user 106 to modify the interests 104 associated with one or more users, convey the interest 104 to one or more users, and/or revoke the interest 104 from one or more users. As used herein, user 106 may include, without limitation, a person, an entity, or a device, such as a smart device, for example. In the example of a smart device, user 106 may be a provisioned device on a distributed ledger system that has permissions to control or manage the content 102 based on the interest 104.

The computing device 100 allows the user 106 to transfer an asset 108 including the content 102 and/or interest 104. The computing device 100 includes one or more computing systems that execute instructions (e.g., as application programs, operating system functionality, or both) to implement one or more operations as described herein. In some examples, the computing device 100 includes a group of processing units or other computing systems. The computing device 100 may include, for example, a desktop computer, a server computer, a kiosk, a set top box, and/or a tabletop device. Additionally, or alternatively, the computing device 100 may include more-portable computing devices, such as a mobile device, a laptop computer, a tablet device, a netbook, a gaming device, a wearable device, and/or a portable media player.

In some examples, the computing device 100 has at least one processor 112 and computer-readable media 114. The processor 112 includes any quantity of processing units, and is programmed to execute computer-executable instructions for implementing aspects of the disclosure. The instructions may be performed, for example, by one or more processors 112 within the computing device 100 (as shown in FIG. 1). Additionally, or alternatively, the instructions may be performed by at least one processor external to the computing device 100. The processor 112 may represent an implementation of analog techniques to perform the operations described herein. For example, the operations may be performed by an analog computing device and/or a digital computing device.

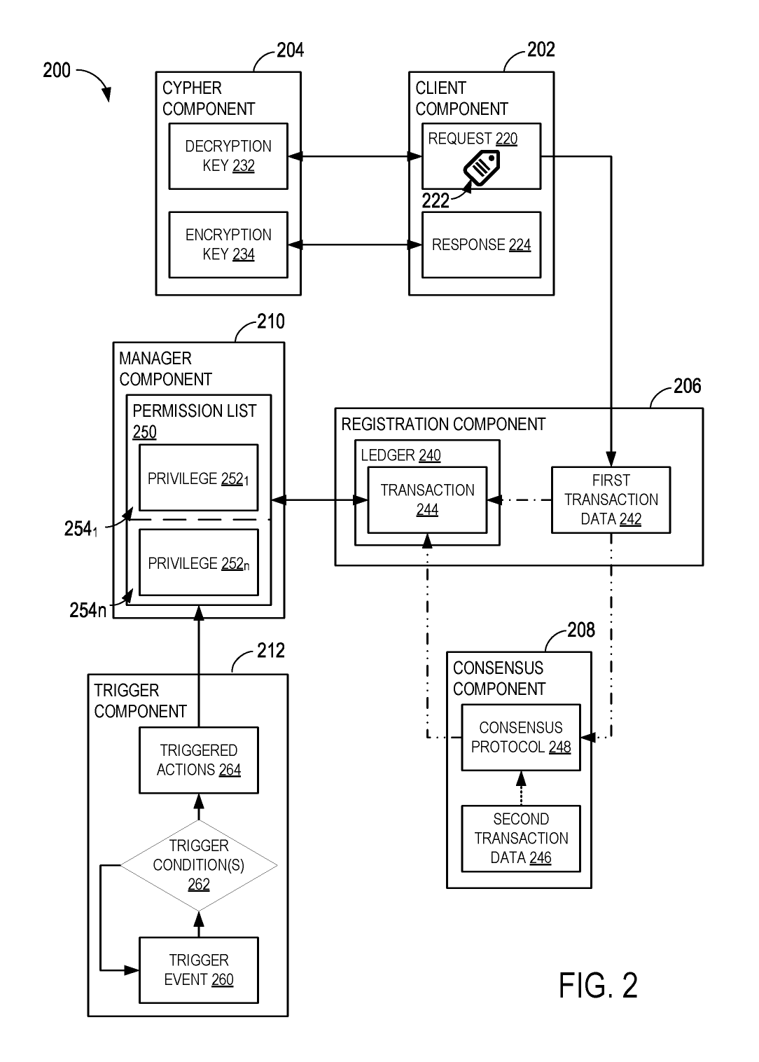

In some examples, the processor 112 is programmed to execute instructions, such as those illustrated in the figures (e.g., FIGS. 2, 6, and 7). The instructions may be stored and/or maintained at the computer-readable media 114. The computer-readable media 114 includes any quantity of media associated with or accessible by the computing device 100. The computer-readable media 114 may be internal to the computing device 100 (as shown in FIG. 1), external to the computing device 100, or both. For example, the computer-readable media 114 may include data stored locally at the computing device 100, data access points stored locally at the computing device 100 and associated with data stored remote from the computing device 100, or any combination of local and remote data. In some examples, the computer-readable media 114 includes read-only memory and/or memory wired into an analog computing device.

The computer-readable media 114 stores and/or maintains, among other data, one or more applications. The applications, when executed by the processor 112, operate to perform one or more operations and/or provide functionality on the computing device 100. Example applications include a content management environment 120, which may represent an application for facilitating content distribution and/or management. The content management environment 120 may provide one or more computer-executable components for managing content 102 and the distribution of content 102. In some examples, the content management environment 120 includes a client module 122, a cypher module 124, a registration module 126, a consensus module 128, a manager module 130, and a trigger module 132.

The client module 122 is a component of the content management environment 120 that identifies one or more transaction requests. The client module 122 is configured to receive and/or identify one or more incoming messages. The incoming messages may be analyzed, for example, to determine whether the incoming messages include and/or are associated with a transaction request associated with a transfer of an asset 108.

In some examples, the client module 122 is configured to identify and/or locate one or more other computing systems and transmit one or more outgoing messages to the other computing systems. The outgoing messages may be transmitted, for example, to one or more computing systems in response to the transaction requests. In some examples, the client module 122 authenticates one or more users 106 and/or one or more computing systems associated with the users 106.

The cypher module 124 is a component of the content management environment 120 that transforms data between a plurality of forms. The cypher module 124 may be used, for example, to protect the computing device 100, the content management environment 120, and/or data transmitted to and/or from the content management environment 120. The cypher module 124 is configured to convert readily-unintelligible data into readily-intelligible data. A message including encrypted information in cyphertext form, for example, may be decrypted to generate and/or identify information in plaintext form. In some examples, the cypher module 124 is configured to convert readily-intelligible data into readily-unintelligible data. A message including information in plaintext form, for example, may be encrypted to generate and/or identify encrypted information in cyphertext form.

The registration module 126 is a component of the content management environment 120 that processes one or more transaction requests. The registration module 126 is configured to analyze the transaction requests to determine whether to approve or not approve (e.g., reject) the transaction requests. In some examples, the registration module 126 generates transaction data associated with the transaction requests. Transaction data associated with one or more approved transaction requests may be registered, for example, to enable one or more computing systems to identify and/or locate a transaction associated with the transaction data. Transaction data may include, for example, a transaction identifier, a user identifier, a device identifier, a transaction date, a transaction time, a transaction location, and/or a transaction amount.

The consensus module 128 is a component of the content management environment 120 that validates one or more transactions associated with one or more transaction requests. The consensus module 128 is configured to determine whether the transaction data associated with the transaction requests is reliable, or at least likely to be reliable. In some examples, the consensus module 128 compares the transaction data with other data to determine whether the other data corroborates or supports the transaction data. The consensus module 128 may determine that the transaction data is reliable, for example, if the other data corroborates or supports the transaction data. One or more transactions associated with one or more transaction requests may be validated on condition that transaction data associated the transaction requests is determined to be reliable.

The manager module 130 is a component of the content management environment 120 that administers or manages one or more transactions in accordance with one or more interests 104. The manager module 130 is configured to identify one or more users 106 and/or assets 108 associated with the transactions, and associate the interests 104 with the users 106 and/or assets 108. The manager module 130 may be used, for example, to demonstrate and/or substantiate that the users 106 are authorized to access, use, modify, copy, and/or distribute an asset 108 associated with the transaction. In some examples, the manager module 130 authorizes the users 106 to access, use, modify, copy, and/or distribute the asset 108 in accordance with the interests 104.

The trigger module 132 is a component of the content management environment 120 that monitors one or more users 106 and/or assets 108 associated with one or more transactions. The trigger module 132 is configured to perform one or more predetermined operations. The predetermined operations may be performed, for example, to facilitate enforcing one or more interests 104 associated with the transactions. For example, the predetermined operations may be used to modify the interests 104 associated with one or more users, convey the interest 104 to one or more users, and/or revoke the interest 104 from one or more users.

In some examples, the computing device 100 includes an interface component 134 stored and/or maintained at the computer-readable media 114. When executed by the processor 112, the interface component 134 may cause the computing device 100 to perform one or more operations and/or provide functionality that facilitate content distribution and/or management communication. The interface component 134 may include computer-executable instructions (e.g., a driver) for operating one or more user interfaces 136 and/or network interfaces 138.

A user interface 136, for example, may be used to present information to and/or receive user input from a user of the computing device 100. User interfaces 136 may include any output and/or input device that enables information to be presented to and/or received from the user, such as a display device, a monitor, a touchscreen panel, a graphics card, a speaker, a sound card, a printer, a vibration motor, a natural user interface, a tablet, a microphone, a keyboard, a pointing device, a sensor device, a digital camera, an accelerometer, and the like. The user interfaces 136 may be internal to the computing device 100 (as shown in FIG. 1), external to the computing device 100, or both.

A network interface 138 may be used to transmit data to and/or receive data from one or more other computing systems. Network interfaces 138 may include any output and/or input device that enables information to be presented to and/or received from another computing system, such as a modem, a network interface controller (NIC), a WI-FI® brand local area wireless computing network-enabled device, a BLUETOOTH® brand wireless technology-enabled device, and/or a near field communication (NFC) wireless communication-enabled device. (WI-FI® is a registered trademark of the Wi-Fi Alliance, and BLUETOOTH® is a registered trademark of Bluetooth Special Interest Group). The network interfaces 138 may be internal to the computing device 100 (as shown in FIG. 1), external to the computing device 100, or both.

In some examples, one or more applications, such as the content management environment 120, communicate with counterpart applications or services such as web services accessible via a communication network 140 that enables data to be transferred between a plurality of computing systems coupled to the communication network 140. For example, the applications may represent server-side applications that enable client-side services to be provided at one or more client devices. In some examples, the computing device 100 communicates with a user device 150 (e.g., via the communication network 140) to allow the user 106 to enter into one or more transactions.

In some examples, the user device 150 provides an instance of the content management environment 120 (e.g., a client-side application) for presenting information to and/or receiving user input from the user 106 while content management operations are performed on the backend at the computing device 100. The user device 150 may include an operating system that enables the instance of the content management environment 120 to be provided in a user-friendly manner. For example, the operating system may include one or more application program interfaces (APIs) that enable the user device 150 to present information to and/or receive user input from the user 106 using a user interface 154 and/or transmit data to and/or receive data from one or more other computing systems (e.g., computing device 100) using a network interface 156.

In some examples, user device 150 may be provisioned as a federated entity to be used in hosting and providing a private key of the associated user, such as user 106, to the distributed ledger used to maintain and control the transactions associated with content 102. User device 150 may enable a user to configure customized levels of control and access of interest 104 and/or content 102 using the instance of the appliance management environment 120 implemented on user device 150. Customized levels of control and access may include: limited access, one-time access, full-authority access, specific channels of activity access, and any other suitable control customization. In other examples, user device 150 may be provisioned to provide private key information for authenticating transactions, such as modifications or authorizations relative to interest 104 for example, but may have restricted management access or otherwise limited authority.

FIG. 2 is a block diagram illustrating an example content management environment 200 for managing content 102. The content management environment 200 is an example of one implementation of the content management environment 120 in FIG. 1. The content management environment 200 includes a client component 202, a cypher component 204, a registration component 206, a consensus component 208, a manager component 210, and a trigger component 212.

The client component 202 is configured to identify a transaction request 220 associated with a transfer of an article (e.g., asset 108) between a plurality of users (e.g., user 106). The client component 202 may communicate with one or more other computing systems (e.g., user device 150) to receive one or more messages. In some examples, the client component 202 processes or analyzes a message to determine whether the message is, includes, or is associated with a transaction request 220. For example, a message including one or more identifiers 222 may be interpreted and/or identified as a transaction request 220. Example identifiers 222 may include, for example, a transaction identifier, an asset identifier, a content identifier, a user identifier, and the like.

In some examples, the client component 202 communicates with the user device 150 to transmit one or more messages. For example, the client component 202 may transmit a response 224 to a transaction request 220 received from the user device 150. In some examples, the client component 202 analyzes the transaction request 220 to generate the response 224. Additionally, or alternatively, the client component 202 may analyze the transaction request 220 to identify and/or locate the user device 150. In some examples, the user device 150 may be identified and/or located using one or more identifiers 222 included in or associated with the transaction request 220.

The cypher component 204 is configured to transform data between a readily-unintelligible form and readily-intelligible form. The cypher component 204 may communicate with the client component 202 to obtain one or more encrypted messages received from the user device 150, such as an encrypted transaction request 220. In some examples, the cypher component 204 processes or analyzes an encrypted message using a decryption key 232 to generate intelligible information (e.g., in plaintext form) corresponding to the encrypted message.

In some examples, the cypher component 204 communicates with the client component 202 to provide one or more encrypted messages for transmission to the user device 150. For example, the cypher component 204 may process a response 224 using an encryption key 234 to generate unintelligible data (e.g., in cyphertext form) corresponding to the response 224 (e.g., an encrypted response 224), and communicate with the client component 202 for transmitting the encoded response 224 to the user device 150.

The registration component 206 is configured to maintain or manage a record or ledger 240. The registration component 206 may communicate with the client component 202 and/or cypher component 204 to obtain one or more transaction requests 220. In some examples, the registration component 206 processes or analyzes the transaction request 220 to identify and/or generate first transaction data 242 associated with the transaction request 220. The first transaction data 242 may be used to determine whether to approve or not approve the transaction request 220 and/or whether to record or register the first transaction data 242 in the ledger 240.

In some examples, the registration component 206 determines whether the asset 108 associated with the transaction request 220 is legitimate or eligible to be transferred, whether the users 106 associated with the transaction request 220 are legitimate or authorized to enter into a transaction associated with a transfer of the asset 108, and/or whether the users 106 agree to enter into the transaction. If the asset 108 is not eligible (e.g., ineligible), a user 106 is not authorized (e.g., unauthorized), and/or a user 106 does not agree, the registration component 206 does not approve the transaction request 220 and/or does not register the first transaction data 242 in the ledger 240. On the other hand, if the asset 108 is eligible, the users 106 are authorized, and the users 106 agree, the registration component 206 approves the transaction request 220 and/or registers the first transaction data 242 in the ledger 240.

The consensus component 208 is configured to validate a transaction 244 associated with the transaction request 220. The consensus component 208 may communicate with the registration component 206 to obtain first transaction data 242 associated with the transaction request 220. Additionally, the consensus component 208 may communicate with one or more other computing systems to determine whether the first transaction data 242 is reliable. In some examples, the consensus component 208 transmits the first transaction data 242 (e.g., a local instance of the transaction request 220) to the other computing systems and/or receive second transaction data 246 associated with the transaction request 220 (e.g., one or more remote instances of the transaction request 220) from the other computing systems. If the first transaction data 242 is the same as or consistent with the second transaction data 246 (e.g., if the second transaction data 246 corroborates or supports the first transaction data 242), the consensus component 208 validates the transaction 244 using the first transaction data 242 and/or the second transaction data 246. On the other hand, if the first transaction data 242 is inconsistent (e.g., conflicts) with the second transaction data 246, the consensus component 208 settles or reconciles one or more inconsistencies between the first transaction data 242 and the second transaction data 246, and validates the transaction 244 using the reconciled transaction data (e.g., first transaction data 242, second transaction data 246, or other transaction data). The inconsistencies may be settled, for example, using a consensus protocol 248.

The manager component 210 is configured to administer or manage the transaction 244 in accordance with one or more interests 104. The manager component 210 may communicate with the registration component 206 to associate a permission list 250 with the transaction 244 and/or with the asset 108 associated with the transaction 244. The permission list 250 may include one or more privileges 252 that allow one or more users 106 to access, use, modify, copy, and/or distribute the content 102, the interest 104, and/or the asset 108 associated with the transaction 244. In some examples, the permission list 250 includes one or more layers 254₁ . . . n. Each layer may be associated with a respective set of privileges 252₁ . . . n that allow a user 106 associated with the layer 254₁ to access, use, modify, copy, and/or distribute the asset 108 in accordance with the set of privileges 252₁.

The trigger component 212 is configured to monitor the users 106 and/or asset 108 associated with the transaction 244. The trigger component 212 may communicate with the manager component 210 to enable the manager component 210 to administer or manage the transaction 244 in accordance with the interests 104. For example, the trigger component 212 may detect and/or identify an occurrence of a predetermined triggering event 260. Upon identification of the occurrence of the triggering event 260, the trigger component 212 evaluates one or more predetermined trigger conditions 262 to determine whether to perform one or more triggered actions 264. Predetermined conditions may be based on, for example, a time, a proximity, a capital resource, a privilege, an event, a security, an authentication, a management, a deployment, a usage, a hash (e.g., a number of hashes on a blockchain), a network (e.g., a connection of keys), and the like. If the trigger conditions 262 are not satisfied, the trigger component 212 continues to monitor the users 106 and/or asset 108 associated with the transaction 244 in accordance with the interests 104. On the other hand, if the trigger conditions 262 are satisfied, the trigger component 212 performs the triggered actions 264. In some examples, the trigger component 212 communicates with the registration component 206 and/or manager component 210 to modify the content 102 and/or permission list 250 associated with the transaction 244.

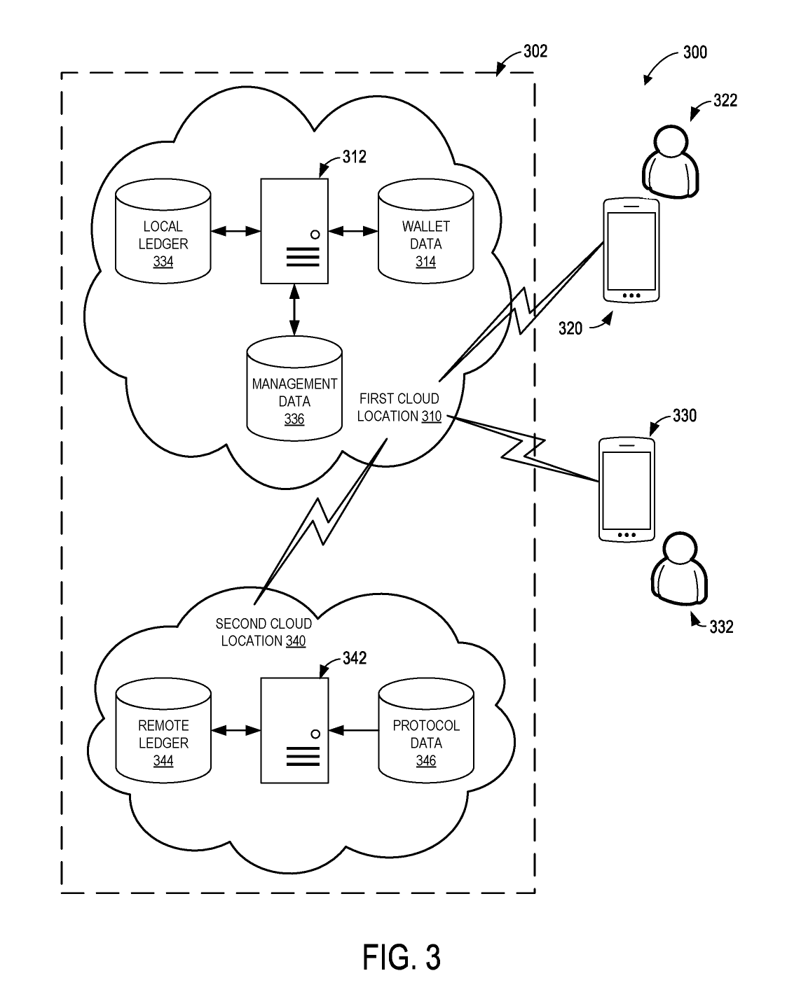

FIG. 3 is a block diagram illustrating an example content management environment 300 operating as a cloud-based service. The content management environment 300 may be an illustrative example of the content management environment 120 in FIG. 1 and/or the content management environment 200 in FIG. 2. The content management environment 300 may be implemented in a cloud-based environment, such as a centralized network 302, with one or more operations performed in the cloud. The centralized network 302 includes a primary or first cloud location 310 at which one or more content management operations, such as those depicted in FIGS. 2, 6, and 7, may be performed.

One or more client devices (e.g., user device 150) may be communicatively coupled to the first cloud location 310 via a communication network (e.g., communication network 140) or other network for distributing content 102 and/or managing distributed content 102. The first cloud location 310 includes a primary or first server system 312 that uses one or more server-side applications to provide one or more client-side services at the user devices 150. Additionally, or alternatively, the user devices 150 may use one or more client-side applications to present information to and/or receive user input from one or more users (e.g., user 106) while content management operations are performed on the backend at the first cloud location 310.

Wallet data 314 allows the user devices 150 to obtain information from and/or provide information to the centralized network 302. For example, wallet data 314 may be used to implement an authentication protocol for establishing one or more secure communication links between the first cloud location 310 and a user device 150. In some examples, wallet data 314 is stored and/or maintained at the first cloud location 310. Additionally, or alternatively, the wallet data 314 may be stored and/or maintained at the user device 150. Wallet data 314 may include, for example, a username, an identification number, a password, a personal identification number (PIN), a signature, a voiceprint, a body posture or gesture, biometric data, a public key infrastructure (PM) certificate, a security token, a BLUETOOTH® brand wireless technology identifier, an RFID identifier, an NFC identifier, a routing number, a media access controller (MAC) address, an Internet Protocol (IP) address, a phone number, an email address, a mailing address, and the like.

A first client device 320 of the client devices allows a first user 322 (e.g., a content creator, a content owner, a content provider) to distribute content 102 to a second client device 330 associated with a second user 332 (e.g., a consumer) and/or manage the distributed content 102 (e.g., at the second client device 330). The first client device 320 may be used, for example, to transmit data to the first server system 312 (e.g., via the communication network 140). The first server system 312 may interpret or identify the transmitted data as a transaction request 220 associated with a transfer of an asset 108 between the first user 322 and the second user 332. The transaction request 220 may be processed to generate first transaction data 242, and store and/or maintain the first transaction data 242 at a local ledger 334. In some examples, the first server system 312 transmits content 102 and/or one or more interests 104 associated with the asset 108 to the second client device 330. Additionally, or alternatively, the first server system 312 may store and/or maintain the asset 108 at the first cloud location 310, and allow the second user 332 to access, use, modify, copy, and/or distribute the asset 108 at the first cloud location 310.

Management data 336 may be used to administer or manage a transaction 244 associated with the transaction request 220 in accordance with the interests 104. For example, the management data 336 may be used to associate a permission list 250 with the transaction 244, and/or monitor the first user 322, second user 332, and/or asset 108 associated with the transaction 244. In some examples, the first server system 312 is configured to automatically authorize the first user 322 to perform one or more first operations and/or authorize the second user 332 to perform one or more second operations in accordance with the interests 104. For example, the first server system 312 may receive a request for authorization associated with accessing, using, modifying, copying, and/or distributing the asset 108 (e.g., from the first client device 320 or second client device 330), and process the request for authorization to determine whether to approve or not approve the request for authorization. Additionally, or alternatively, the first server system 312 may store and/or maintain the management data 336 at the first cloud location 310 to demonstrate and/or substantiate that the first user 322 is authorized to perform the first operations and/or the second user 332 is authorized to perform the second operations.

The first cloud location 310 may be communicatively coupled to a secondary or second cloud location 340 (e.g., via the communication network 140) that enables the first server system 312 to provide one or more content management services. The second cloud location 340 may include, for example, one or more secondary or second server systems 342 that support one or more content management operations performed at the first server system 312. In some examples, the first server system 312 communicates with the second server systems 342 to validate one or more transactions associated with the local ledger 334, including the transaction 244 associated with the first transaction data 242, using transaction data stored and/or maintained at one or more remote ledgers 344 e.g., second transaction data 246). Protocol data 346 may be used to implement a consensus protocol 248 for validating the transactions.

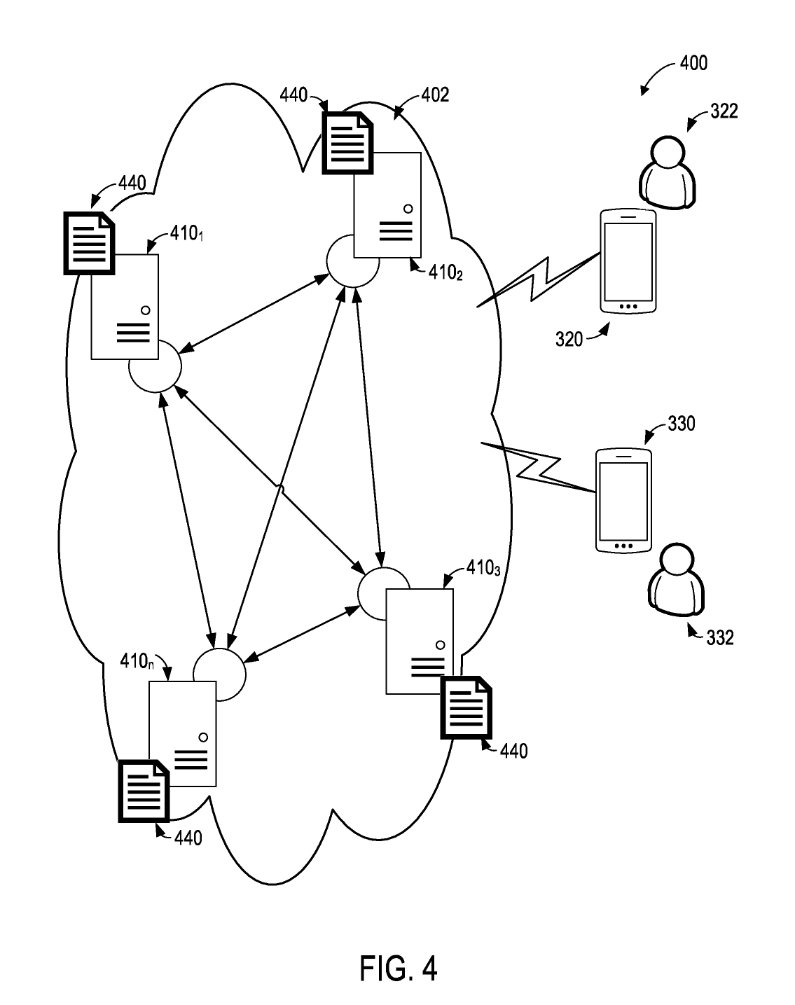

FIG. 4 is a block diagram illustrating another example content management environment 400 operating as a cloud-based service. The content management environment 400 may be an illustrative example of the content management environment 120 in FIG. 1 and/or the content management environment 200 in FIG. 2. The content management environment 400 may be implemented in a cloud-based environment, such as a distributed network 402, with one or more operations performed in the cloud. The distributed network 402 includes a plurality of nodes 410_{1 . . . n} at which one or more content management operations, such as those depicted in FIGS. 2, 6, and 7, may be performed.

As with the centralized network 302, one or more client devices (e.g., user device 150), such as first client device 320 and/or second client device 330, may be communicatively coupled to one or more cloud locations via a communication network (e.g., communication network 140) or other network for distributing content 102 and/or managing distributed content 102. Each cloud location includes a node 410. In some examples, one or more nodes 410_{1 . . . n} use one or more server-side applications to provide one or more client-side services at the first client device 320 and/or second client device 330. Additionally, or alternatively, the first client device 320 and/or second client device 330 may use one or more client-side applications to present information to and/or receive user input from the first user 322 and/or second user 332, respectively, while content management operations are performed on the backend at one or more nodes 410_{1 . . . n}.

Wallet data (e.g., wallet data 314) allows the first client device 320 and second client device 330 to obtain information from and/or provide information to the distributed network 402. For example, wallet data may be used to implement an authentication protocol for establishing one or more secure communication links between a node 410 and the first client device 320 or second client device 330. In some examples, wallet data is stored and/or maintained at one or more nodes 410_{1 . . . n}. Additionally, or alternatively, the wallet data may be stored and/or maintained at the first client device 320 and/or second client device 330.

In some examples, the first user 322 uses wallet data associated with the first user 322 and/or second user 332 to generate a transaction request 220 associated with a transfer of an asset 108 between the first user 322 and the second user 332, and broadcasts the transaction request 220 to the distributed network 402. In this manner, one or more nodes 410_{1 . . . n} in the distributed network 402 may obtain the transaction request 220. The wallet data may include, for example, a private key associated with the first user 322, a public key associated with the second user 332, a representation of the private key and/or public key (e.g., an encrypted key, a hash, an encrypted hash), and/or a link to the private key and/or public key.

Upon obtaining the transaction request 220, a node 410 processes the transaction request 220 to generate transaction data 440 (e.g., first transaction data 242, second transaction data 246) and broadcasts the transaction data 440 to the distributed network 402. Each node 410 that obtains a transaction request 220 may independently process the transaction request 220 to generate an instance of the transaction data 440. In this manner, a node 410 may transmit an instance of the transaction data 440 that is local to that node 410 (e.g., a local instance) to one or more other nodes 410 and/or receive one or more instances of the transaction data 440 that are local to one or more other nodes 410 (e.g., one or more remote instances) from those other nodes 410. A node 410 may be configured to broadcast transaction data 440 that is new to that node 410. For example, the node 410 may broadcast transaction data 440 generated at that node 410 and/or rebroadcast transaction data 440 received from one or more other nodes 410_{1 . . . n}.

One or more nodes 410_{1 . . . n} in the distributed network 402 record or register transaction data 440 in a record or ledger (e.g., ledger 240). Each node 410 that generates and/or receives transaction data 440 may independently register the transaction data 440 in a ledger 240 that is local to that node 410. In some examples, the node 410 uses a transaction identifier associated with the transaction data 440 to determine whether to register the transaction data 440. The transaction identifier may include, for example, a public key associated with the first user 322 and/or second user 332, a representation of the public key (e.g., an encrypted key, a hash, an encrypted hash), and/or a link to the public key.

If the ledger 240 does not include an instance of the transaction data 440 (e.g., the ledger 240 does not include transaction data associated with a transaction identifier that corresponds to or matches the transaction identifier associated with the transaction data 440), the node 410 registers the transaction data 440 in the ledger 240. On the other hand, if the ledger 240 includes an instance of the transaction data 440, the node 410 implements a consensus protocol 248 to determine whether to accept, reject, or modify the transaction data in the ledger 240 and/or the transaction data 440. If there is consensus among the nodes 410 in the distributed network 402, a transaction 244 associated with the transaction data 440 may be validated.

In some examples, the first server system 312 transmits content 102 and/or one or more interests 104 associated with the asset 108 to the second client device 330. Additionally, or alternatively, the first server system 312 may store and/or maintain the asset 108 at one or more nodes 410_{1 . . . n} in the distributed network 402, and allow the second user 332 to access, use, modify, copy, and/or distribute the asset 108 at the one or more nodes 410_{1 . . . n}. The first client device 320, second client device 330, and/or one or more nodes 410_{1 . . . n} may be used to administer or manage a transaction 244 associated with the transaction request 220 in accordance with the interests 104.

In some examples, one or more nodes 410_{1 . . . n} are configured to automatically authorize the first user 322 to perform one or more first operations in accordance with a first set of privileges and/or authorize the second user 332 to perform one or more second operations in accordance with a second set of privileges. For example, one or more nodes 410_{1 . . . n} may receive a content request associated with accessing, using, modifying, copying, and/or distributing the content 102 (e.g., from the first client device 320 or second client device 330), and analyze the content request to determine whether to approve or not approve the content request. If the content request is associated with the first user 322, the node 410 communicates with the first client device 320 in accordance with the first set of privileges. If the content request is associated with the second user 332, the node 410 communicates with the second client device 330 in accordance with the second set of privileges. In some examples, one or more nodes 410_{1 . . . n} store and/or maintain management data (e.g., management data 336) to demonstrate and/or substantiate that the first user 322 is authorized to perform the first operations and/or the second user 332 is authorized to perform the second operations.

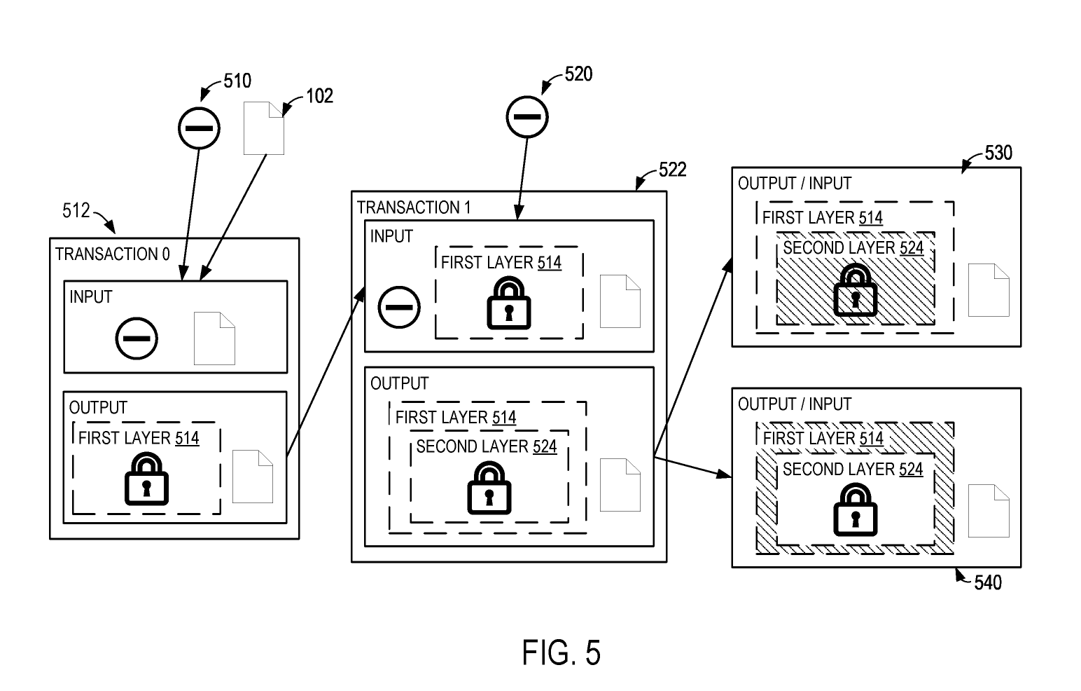

FIG. 5 is a block diagram illustrating example layers for managing content 102 using blockchain technology. Content 102 itself, or data representative of the content 102, is accessible, usable, modifiable, copyable, and/or distributable by one or more users, including a content creator, a content owner, and/or a content provider (e.g., first user 322). To facilitate controlling or managing the content 102, blockchain technology may be used to record one or more transactions (e.g., transaction 244) associated with the content 102 in a ledger (e.g., ledger 240) in a transparent and verifiable manner. The ledger 240 may be used to demonstrate and/or substantiate that the content 102 is legitimate or eligible to be transferred, that the parties to the transaction 244 have the capacity or authority to enter into the transaction 244, and/or that the parties agree to enter into the transaction 244. Moreover, the ledger 240 may be used to selectively control the content 102 and/or use of the content 102 (e.g., access, use, modification, copying, distribution) to maintain an integrity of the content 102.

Interests 104 may be associated with the content 102 to demonstrate and/or substantiate a claim or privilege to the content 102 and/or a permission to exercise a privilege from the claim (e.g., a license). In some examples, the first user 322 constructs a first permission list 510 that may be used to selectively allow one or more users to access, use, modify, copy, and/or distribute the content 102, and/or selectively restrict one or more users from accessing, using, modifying, copying, and/or distributing the content 102. The first permission list 510 may be associated with the content 102 at a genesis transaction, Transaction 0, represented at 512. Input to Transaction 0 includes the content 102 and first permission list 510, and output from Transaction 0 includes the content 102 and a first layer 514 associated with the first permission list 510 (e.g., a primary first layer). The first layer 514 may include a first identifier associated with the first user 322 and first role data defining a set of rights or privileges (e.g., privileges 252) such that the first user 322 is associated with the set of rights or privileges. In this manner, the first user 322 may be allowed to access, use, modify, copy, and/or distribute the content 102 in accordance with the first role data after Transaction 0.

To transfer at least some interest 104 associated with the content 102 to a consumer (e.g., a second user 332), the first user 322 may use at least a portion of the output from Transaction 0. For example, the first user 322 may construct a second permission list 520, and associate the second permission list 520 with the content 102 at a first transaction, Transaction 1, represented at 522. Input to Transaction 1 includes the output from Transaction 0 (e.g., the content 102 and first layer 514) and the second permission list 520, and output from Transaction 1 includes the content 102, the first layer 514, and a second layer 524 associated with the second permission list 520 (e.g., a primary second layer). The second layer 524 may include a second identifier associated with the second user 332 and second role data defining a subset of privileges such that the second user 332 is associated with the subset of privileges. In this manner, the second user 332 may be allowed to access, use, modify, copy, and/or distribute the content 102 in accordance with the second role data after Transaction 1. In some examples, the second layer 524 is overlaid on the first layer 514 to demonstrate and/or substantiate an implementation of the second permission list 520. For example, implementation of the second permission list 520 may modify at least some first role data associated with the first layer 514 to define a remainder subset of rights or privileges (e.g., the set of rights or privileges less the subset of privileges).

The first user 322 and/or second user 332 may transfer their respective interests 104 to another user, including each other, in accordance with the first role data and the second role data, respectively. The first user 322 and/or second user 332 may use a portion of the output from Transaction 1 corresponding to their respective interests 104 as input to another transaction. For example, the first user 322 may transfer another asset to another user (e.g., second user 332, third user) using a first portion of the output from Transaction 1 represented at 530 (e.g., the remainder subset of rights or privileges) as input to another transaction. Similarly, the second user 332 may transfer another asset to another user (e.g., first user 322, third user) using a second portion of the output from Transaction 1 represented at 540 (e.g., the subset of privileges) as input to another transaction.

If a second portion of the output from Transaction 1 represented at 540 is used as input to a transaction associated with a transfer of an asset from the second user 332 to another user, a permission list (e.g., permission list 250) including a first layer (e.g., a secondary first layer subject to the primary first layer 514) associated with the second user 332 and a second layer (e.g., a secondary second layer) associated with the other user may be constructed and implemented. The secondary first layer may include the second identifier associated with the second user 332 and role data (e.g., third role data) defining a set of privileges associated with the second user 332, and the secondary second layer may include a third identifier associated with the other user and role data (e.g., fourth role data) defining a set of privileges associated with the other user.

In some examples, the asset 108 includes event condition action data defining a trigger. The trigger may be executed to enter into another transaction that revokes the subset of privileges from the second user 332. For example, the second portion of the output from Transaction 1 represented at 540 (e.g., the subset of privileges) may be used as input to a transaction associated with a transfer of an asset from the second user 332 to the first user 322. Upon execution of the trigger, the first role data may define a set of rights or privileges that are not restricted by the subset of privileges.

Data associated with the transactions (e.g., Transaction 0, Transaction 1) may be stored on a blockchain. A plurality of transactions may be chained together in chronological order to form a block. For example, an input to a transaction may be associated with an output from a previous transaction, and/or an output from a transaction may be associated with an input to a subsequent transaction. In some examples, an output from a transaction may be spent or used once. For example, upon using an output from a transaction as an input to another transaction, the output may be identified or recognized as being spent. Using a spent output as an input to a transaction may render the transaction invalid (e.g., the transaction may be rejected). In some examples, an output may be partitioned for use as an input to a plurality of transactions, and/or a plurality of outputs may be combined for use as an input to a single transaction.

A plurality of blocks may be chained together in chronological order to form a blockchain. A block includes a block header and a hash of a previous block's block header. Additionally, the block header may be hashed and stored in a subsequent block. The block header may include an identifier associated with one or more transactions in the block. In some examples, the transactions in a block are iteratively hashed and paired to generate the identifier (e.g., a merkle root of a merkle tree).

The blocks may be traversed in reverse chronological order to validate one or more transactions in the blockchain. A proof of work, for example, may be used to demonstrate and/or substantiate that one or more operations were performed to validate a transaction and/or generate a block. In some examples, a node 410 in a distributed network 402 may analyze transaction data 440 associated with the transaction to check that a local version of the blockchain is in sync with other versions in the distributed network 402. If the distributed network 402 includes a plurality of versions of the blockchain, a consensus protocol 248 may be implemented to identify a valid version. The valid version may be identified based on a block height or length.

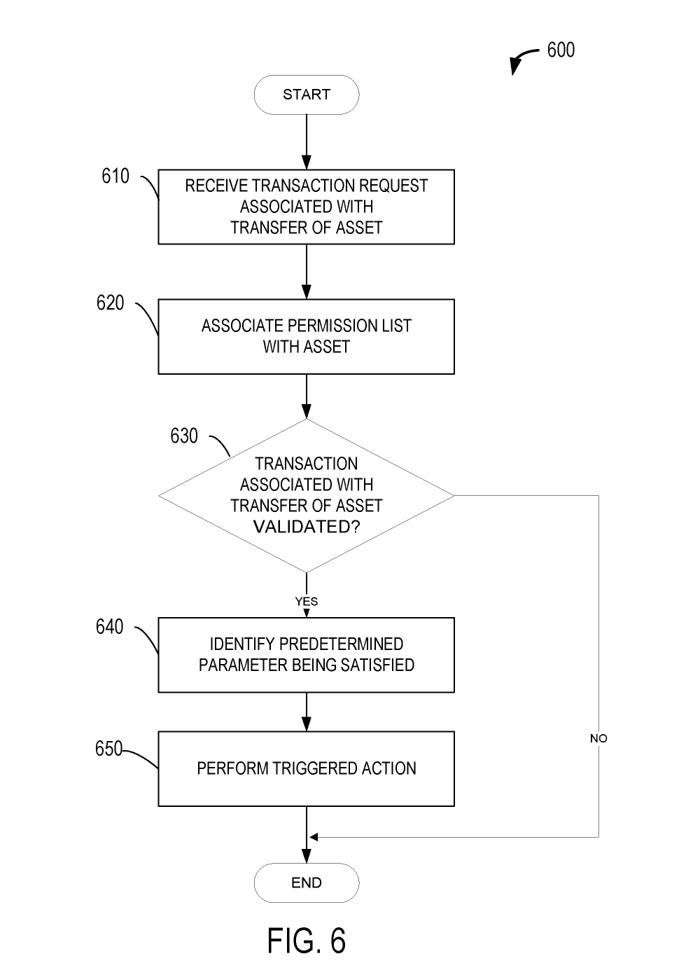

FIG. 6 is a flowchart illustrating an example method for managing distributed content 102. The method 600 may be implemented at the computing device 100. For example, the method 600 may be implemented using the content management environment 120 in FIG. 1 and/or the content management environment 200 in FIG. 2. Additionally, the method 600 may be implemented in the content management environment 300 in FIG. 3 and/or the content management environment 400 in FIG. 4.

In some examples, a transaction request 220 associated with a transfer of an asset 108 between a plurality of users 106 is received at operation 610. The asset 108 may be representative of a first user 322 (e.g., a content creator, a content owner, a content provider) conveying content 102 and/or an interest 104 to a second user 332 (e.g., a consumer). The transaction request 220 may be received, for example, from a first client device 320 associated with the first user 322 and/or second client device 330 associated with the second user 332. Alternatively, the transaction request 220 may be received from any computing system associated with any user that enables the computing device 100 to function as described herein, including a computing system associated with a third party.

A permission list 250 including a plurality of layers 254 is associated at operation 620 with the asset 108. The layers 254 may be asymmetrical to represent that the interest 104 of the first user 322 in the content 102 is different from the interest 104 of the second user 332 in the content 102. For example, each layer 254 may include a respective identifier 222 associated with a respective user 106 and respective role data defining a set of privileges 252. In this manner, each user 106 is authorized to access, use, modify, copy, and/or distribute the asset 108 in accordance with the respective role data defining the set of privileges 252. For example, the first user 322 may be associated with a first layer 514 demonstrating and/or substantiating an authorization to perform one or more first operations corresponding to a first set of privileges associated with the first layer 514, and the second user 332 may be associated with a second layer 524 demonstrating and/or substantiating an authorization to perform one or more second operations corresponding to a second set of privileges associated with the second layer 524.

A determination is made as to whether a transaction 244 associated with the transfer of the asset 108 is validated at operation 630. In some examples, the computing device 100 communicates with a computing system to validate the transaction 244. For example, the computing device 100 may transmit first transaction data 242 to the second server system 342 and/or receive or retrieve second transaction data 246 from the second server system 342 to enable the first transaction data 242 to be compared with the second transaction data 246 for validating the transaction 244. For another example, the computing device 100 may transmit first transaction data 242 to one or more nodes 410 in a network (e.g., distributed network 402) and/or receive or retrieve second transaction data 246 from the nodes 410.

In some examples, the computing device facilitates administering or managing the transaction 244 in accordance with one or more interests 104. In addition to allowing each user 106 to access, use, modify, copy, and/or distribute the asset 108 in accordance with the respective role data defining the set of privileges 252, the users 106 and/or asset 108 may be monitored in accordance with event condition action data defining a trigger. In some examples, the event condition action data is included in or associated with the first layer 514. Alternatively, the event condition action data may be included in or associated with any combination of layers that enable the computing device 100 to function as described herein, including a layer associated with one or more users 106 (e.g., first layer 514, second layer 524), a layer associated with no users, or no layer.

Upon identifying at operation 640 a satisfaction of a predetermined parameter (e.g., trigger condition 262), the trigger is executed to perform at operation 650 one or more triggered actions 264. Additionally, or alternatively, the trigger may be executed upon identifying an occurrence of one or more triggering events 260. In some examples, the triggered actions 264 are associated with one or more modifications to the asset 108. The asset 108 may be modified to disassociate the second user 332 from the second layer 524. In this manner, the second set of privileges may be revoked from the second user 332 upon execution of the trigger such that the second user 332 is not authorized to perform the second operations.

In some examples, the computing device 100 communicates with a computing system (e.g., second server system 342, node 410) to validate another transaction associated with another transfer of the asset 108 between the first user 322 and the second user 332. The second transfer of the asset 108 may be representative of the second user 332 conveying content 102 and/or interest 104 to the first user 322. That is, the second transfer of the asset 108 may be a reversal of the first transfer of the asset 108.

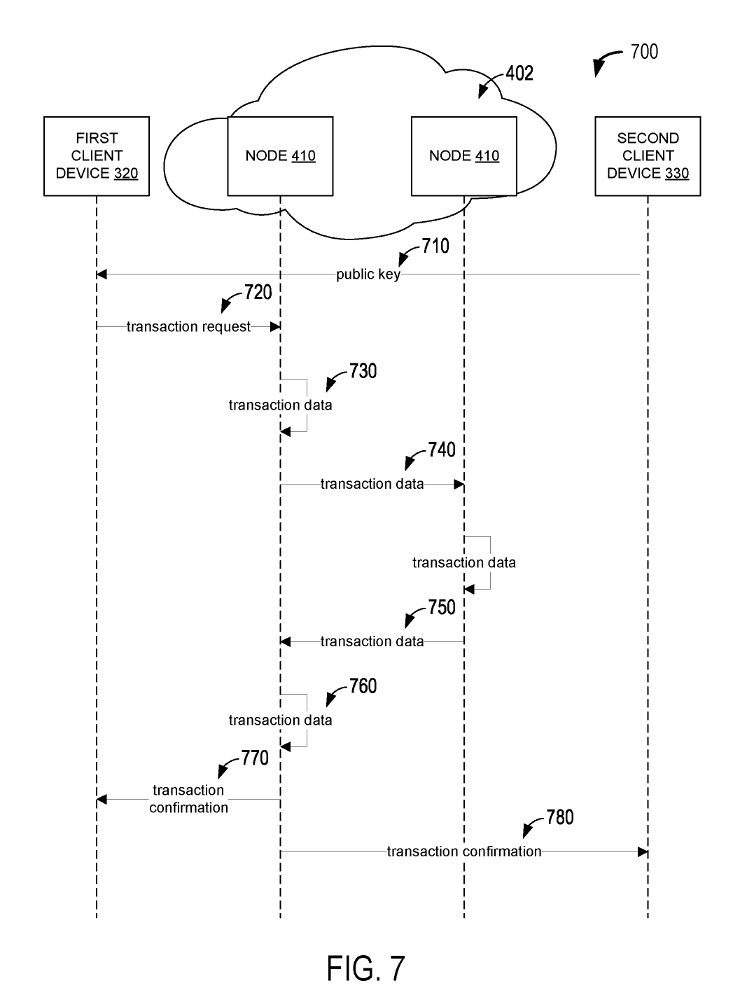

FIG. 7 is a sequence diagram illustrating an example method 700 for managing content 102 using a distributed network 402. The method 700 may be implemented at the computing device 100. For example, the method 700 may be implemented using the content management environment 120 in FIG. 1 and/or the content management environment 200 in FIG. 2.

A first client device 320 associated with a first user 322 may receive at operation 710 an identifier from a second client device 330 associated with a second user 332. The identifier may include, for example, a public key associated with the second user 332, a representation of the public key (e.g., an encrypted key, a hash, an encrypted hash), and/or link to the public key. The first client device 320 uses the identifier to generate a transaction request 220 associated with a transfer of an asset 108 between the first user 322 and the second user 332. The asset 108 may include, for example, the content 102 itself (e.g., a digital product) and/or interest 104 (e.g., a license) associated with the content 102.

The first client device 320 may broadcast at operation 720 the transaction request 220 to a distributed network 402 such that one or more nodes 410 in the distributed network 402 may obtain the transaction request 220. Alternatively, the first client device 320 may transmit the transaction request 220 to a node 410, and the node 410 may broadcast the transaction request 220 to the distributed network 402. Upon receiving the transaction request 220, a node 410 analyzes the transaction request 220 to generate transaction data 440 and registers at operation 730 the transaction data 440 in a ledger. The node 410 broadcasts at operation 740 the transaction data 440 to the distributed network 402 for validating the transaction data 440. If the node 410 receives at operation 750 a remote instance of the transaction data 440, the node 410 analyzes the transaction data 440 to validate at operation 760 the transaction data 440. In some examples, the node 410 generates and transmits at operation 770 a response to the transaction request to the first client device 320. The response may include a transaction confirmation. Additionally, or alternatively, the node 410 may generate and/or transmit at operation 780 a transaction confirmation to the second client device 330.

The transaction 244 may be administered or managed in accordance with one or more interests 104 associated with the asset 108. For example, the transaction 244 may be managed and/or monitored in accordance with role data. In some examples, a transaction request associated with another transfer of the asset 108 and/or a transfer of another asset associated with the content 102 (e.g., a second asset) is received from the first client device 320 and/or second client device 330. The transfer may be between the first user 322 and the second user 332, between the first user 322 and a third user, and/or between the second user 332 and the third user. The asset 108 and/or other asset may be analyzed to determine whether the transfer is in accordance with the first set of privileges and/or second set of privileges. If the transfer is in accordance with the first set of privileges and/or second set of privileges (e.g., the transfer does not conflict with the interests 104 associated with the asset 108), another permission list (e.g., a second permission list) may be associated with the asset 108 and/or other asset.

For another example, the transaction 244 may be managed and/or monitored in accordance with event condition action data. Upon identifying an occurrence of a triggering event and/or a satisfaction of a trigger condition, the node 410 generates transaction data associated with a triggered transaction, registers the transaction data, and/or broadcasts the transaction data to the distributed network 402 for validating the transaction data. In some examples, the node 410 generates the transaction data in response to receiving, from the first client device 320 and/or second client device 330, a transaction request associated with the triggered transaction.

In addition, a user may view and modify levels of control and access of interest and content managed in the distributed ledger system. This enables a user to dynamically control and modify the levels of access and control for each asset on the system. As another example, a user may modify a level of access for dedicated or pre-defined time intervals, such as a temporary license to use and/or modify content.

The system and methods provided herein enable a user to access and view historical data pertaining to content actions, modifications, and the like, which are saved in the distributed ledger. All actions, negotiations, transactions, and interactions made in connection with the content generate subsequent blocks stored in the chain of the distributed ledger. This enables a user to view previous interactions and transactions at their discretion.

Alternatively, or in addition to the other examples described herein, examples include any combination of the following:
receiving a transaction request associated with a transfer of an asset between a plurality of users;
analyzing a transaction request to determine whether the transaction request is in accordance with a set of privileges;
analyzing an asset to determine whether a transfer of an asset is in accordance with a set of privileges;
constructing a permission list including a plurality of layers;
associating a permission list with an asset;
associating a permission layer with a user such that the user is associated with a set of privileges;
identifying a network including one or more nodes;
transmitting a local instance of a transaction request to one or more nodes in a network;
receiving one or more remote instances of a transaction request from one or more nodes in a network;
implementing a consensus protocol to validate a transaction associated with a transfer of an asset;
validating a transaction associated with a transfer of an asset;
receiving a notification associated with a validation of a transaction;
transmitting a response to a transaction request;
transmitting a confirmation of a transaction;
monitoring an asset and/or a user;
detecting an occurrence of a triggering event;
evaluating a trigger condition to determine whether a predetermined parameter is satisfied;
identifying that a predetermined parameter is satisfied;
transmitting a request associated with an identification of a predetermined parameter being satisfied;
transmitting a notification of a predetermined parameter being satisfied;
determining whether a transfer of an asset is to be performed for modifying a permission layer;
transmitting an instruction to perform a transfer of the asset;
performing one or more triggered actions;
identifying a content request associated with distributed content;
analyzing a content request to determine whether the content request is associated with a user;
analyzing a content request to determine whether the content request is in accordance with a set of privileges;
communicating with a client device in accordance with a set of privileges; and
transmitting distributed content.

In some examples, the operations illustrated in FIGS. 2, 6, and 7 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure. Moreover, while at least some examples of the disclosure are directed to a content distribution and/or management environment, aspects of the disclosure may be provided in a variety of environments in which user access and/or use is managed. Examples of the disclosure may be used, for example, to manage any of a variety of digitized items including, without limitation: digital cash, intellectual property, private financial data, chain of title to one or more rights, real property, digital wallet, digital representation of rights (e.g., license to intellectual property), digital representation of a contractual relationship, medical records, security clearance rights, background check information, passwords, access control information for physical or virtual space, and the like.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Example Operating Environment

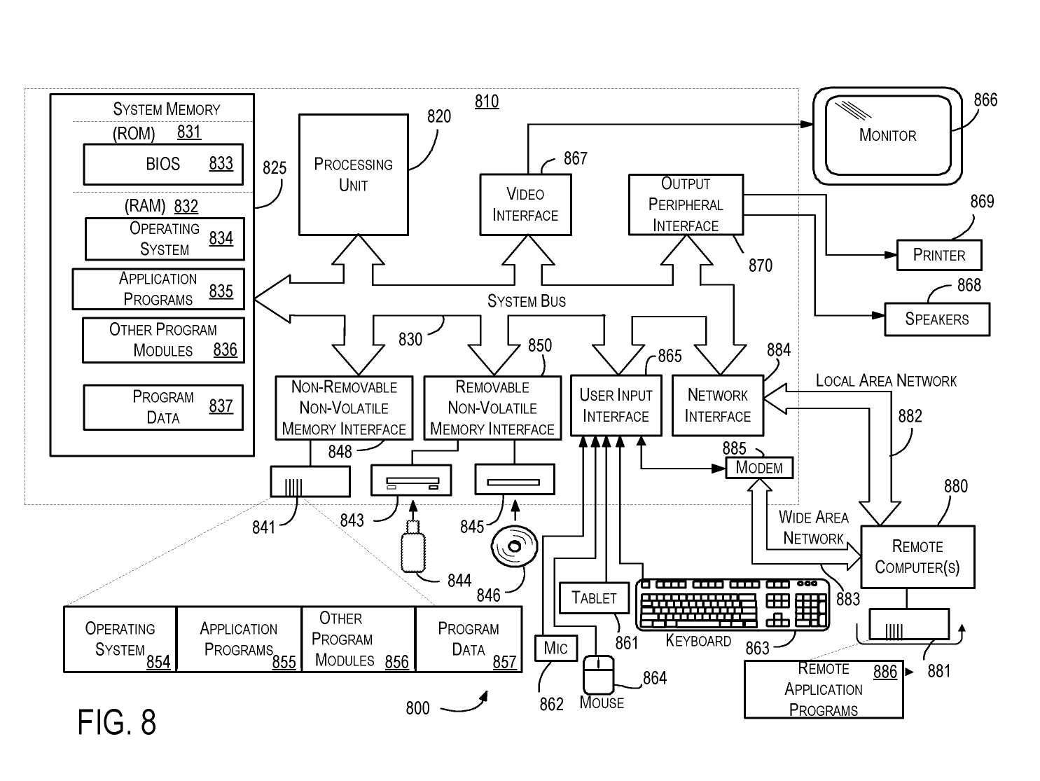

FIG. 8 is a block diagram illustrating an example operating environment 800 for a computing device (e.g., computing device 100). The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the example operating environment 800.

The disclosure is operational with numerous other general purpose or special purpose computing system environments or configurations. Examples of well-known computing systems, environments, and/or configurations that may be suitable for use with the disclosure include, but are not limited to: personal computers, desktop computers, laptop computers, tablet devices, netbooks, handheld devices, mobile telephones, wearables, gaming devices, portable media players, server computers, kiosks, set top boxes, tabletop devices, multiprocessor systems, microprocessor-based systems, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an example system for implementing various aspects of the disclosure may include a general-purpose computing device in the form of a computer 810. Components of the computer 810 may include, but are not limited to, a processing unit 820, a system memory 825, and a system bus 830 that couples various system components including the system memory to the processing unit 820. The system bus 830 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Read only memory (ROM) 831 and random-access memory (RAM) 832 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 825 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as application programs 835 (e.g., content management environment), other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 843 that provides for reads from or writes to a removable, nonvolatile memory 844, and an optical disk drive 845 that reads from or writes to a removable, nonvolatile optical disk 846 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 841 is typically connected to the system bus 830 through a non-removable memory interface such as interface 848, and USB port 843 and optical disk drive 845 are typically connected to the system bus 830 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 854, application programs 855 (e.g., a content management environment), other program modules 856 and program data 857. Note that these components may either be the same as or different from operating system 834, application programs 835, other program modules 836, and program data 837. Operating system 854, application programs 855, other program modules 856, and program data 857 are given different numbers herein to illustrate that, at a minimum, they are different copies.

A user may enter commands and information into the computer 810 through input devices such as a tablet, or electronic digitizer, 861, a microphone 862, a keyboard 863 and pointing device 864, commonly referred to as mouse, trackball or touch pad. Other input devices not shown in FIG. 8 may include a joystick, game pad, digital camera, scanner, or the like. These and other input devices are often connected to the processing unit 820 through a user input interface 865 that is coupled to the system bus, but may be connected by other interface and bus structures, such as a parallel port, game port or a universal serial bus (USB). A monitor 866 or other type of display device is also connected to the system bus 830 via an interface, such as a video interface 867. The monitor 866 may also be integrated with a touchscreen panel or the like. Note that the monitor and/or touchscreen panel may be physically coupled to a housing in which the computing device 810 is incorporated, such as in a tablet device. In addition, computers such as the computing device 810 may also include other peripheral output devices such as speakers 868 and printer 869, which may be connected through an output peripheral interface 870 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 882 and one or more wide area networks (WAN) 883, but may also include other networks. Such networking environments are commonplace in offices, enterprise-wide computer networks, intranets and the Internet.

When used in a LAN networking environment, the computer 810 is connected to the LAN 882 through a network interface controller or adapter 884. When used in a WAN networking environment, the computer 810 typically includes a modem 885 or other means for establishing communications over the WAN 883, such as the Internet. The modem 885, which may be internal or external, may be connected to the system bus 830 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communication link between the computers may be used.

The examples illustrated and described herein as well as examples not specifically described herein but within the scope of aspects of the disclosure constitute an example content management environment. For example, the elements illustrated in FIGS. 1-5, 7, and 8, such as when encoded to perform the operations illustrated in FIGS. 6 and 7, constitute an example means for receiving a transaction request associated with a transfer of an asset (e.g., client module 122, client component 202); an example means for associating a permission list with an first asset (e.g., manager module 130, manager component 210); an example means for communicating with one or more nodes in a network to validate a transaction associated with a transfer of an asset (e.g., registration module 126, registration component 206); and/or an example means for executing a trigger to perform one or more triggered actions (e.g., trigger module 132, trigger component 212).

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A computer-implemented method for managing distributed content, the computer-implemented method comprising:
receiving, from a first client device associated with a first user, a first transaction request associated with a first transfer of a first asset between the first user and a second user, the first asset associated with the distributed content;
associating a first permission list with the first asset, the first permission list including a primary first layer and a primary second layer, the primary first layer including a first identifier associated with the first user, first role data defining a first set of privileges associated with the first user, and event condition action data defining a trigger configured to execute on condition that a predetermined parameter is satisfied, the primary second layer including a second identifier associated with the second user and second role data defining a second set of privileges associated with the second user;
communicating with one or more nodes in a network to validate a first transaction associated with the first transfer of the first asset; and
upon identification of the predetermined parameter being satisfied, executing the trigger to perform one or more triggered actions, the one or more triggered actions comprising communicating with the one or more nodes in the network to validate a second transaction associated with a second transfer of the first asset between the first user and the second user, the second transfer associated with a modification of the primary second layer.

2. The computer-implemented method of claim 1, further comprising transmitting, to the first client device, a response to the first transaction request, the response including a confirmation of the first transaction.

3. The computer-implemented method of claim 1, further comprising transmitting, to a second client device associated with the second user, a confirmation of the first transaction.

4. The computer-implemented method of claim 1, further comprising:
receiving, from one of the first client device or a second client device associated with the second user, a second transaction request associated with a second transfer of the first asset between the first user and the second user, the second transaction request including a notification of the predetermined parameter being satisfied; and
transmitting, to the one of the first client device or the second client device, a confirmation of the second transaction.

5. The computer-implemented method of claim 1, further comprising:
detecting an occurrence of a triggering event, the triggering event associated with the trigger;
evaluating a trigger condition to determine whether the predetermined parameter is satisfied; and
on condition that the predetermined parameter is satisfied, transmitting, to one or more of the first client device or a second client device associated with the second user, a notification of the predetermined parameter being satisfied, and transmitting, to one or more of the first client device or the second client device, a confirmation of the second transaction.

6. The computer-implemented method of claim 1, further comprising:
identifying a content request associated with the distributed content;
analyzing the content request to determine whether the content request is associated with one of the first user or the second user;
on condition that the content request is associated with the first user, communicating with the first client device in accordance with the first set of privileges; and
on condition that the content request is associated with the second user, communicating with a second client device associated with the second user in accordance with the second set of privileges.

7. The computer-implemented method of claim 1, further comprising:
receiving, from the first client device, a second transaction request associated with a transfer of a second asset between the first user and a third user, the second asset associated with the distributed content;
analyzing the second asset to determine whether the transfer of the second asset is in accordance with the first set of privileges; and
on condition that the transfer of the second asset is in accordance with the first set of privileges, associating a second permission list with the second asset, and communicating with the one or more nodes in the network to validate a transaction associated with the transfer of the second asset.

8. The computer-implemented method of claim 1, further comprising:
receiving, from a second client device associated with the second user, a second transaction request associated with a transfer of a second asset between the second user and a third user, the second asset associated with the distributed content;
analyzing the second asset to determine whether the transfer of the second asset is in accordance with the second set of privileges; and
on condition that the transfer of the second asset is in accordance with the second set of privileges, associating a second permission list with the second asset, and communicating with the one or more nodes in the network to validate a transaction associated with the transfer of the second asset.

9. The computer-implemented method of claim 8, wherein associating the second permission list with the second asset comprises generating the second permission list such that the second permission list includes a secondary first layer and a secondary second layer, the secondary first layer including the second identifier associated with the second user and third role data defining a third set of privileges associated with the second user, the secondary second layer including a third identifier associated with the third user and fourth role data defining a fourth set of privileges associated with the third user.

10. A computing system for managing distributed content, the computing system comprising:
a memory device storing data associated with the content and computer-executable instructions; and
a processor configured to execute the computer-executable instructions to:
construct a permission list including a first layer and a second layer, the first layer defining a first set of privileges and a set of triggers, a first trigger of the set of triggers configured to modify the second layer on condition that a predetermined parameter is satisfied, the second layer defining a second set of privileges;
associate the permission list with a first transaction regarding the distributed content between a first user and a second user, such that the first layer is associated with the first user, and the second layer is associated with the second user;
identify a network including one or more nodes;
transmit, to the one or more nodes, a first request associated with the first transaction;
receive, from the one or more nodes, a first notification associated with a first validation, the first validation associated with the first transaction; and
on condition that the predetermined parameter is satisfied, receive, from the one or more nodes, a second notification associated with a second validation, the second validation associated with a second transaction regarding the distributed content between the first user and the second user, the second transaction associated with an execution of the first trigger.

11. The computing system of claim 10, wherein the processor is further configured to execute the computer-executable instructions to transmit, to a user device associated with the second user, the distributed content.

12. The computing system of claim 10, wherein the processor is further configured to execute the computer-executable instructions to transmit, to the one or more nodes, the distributed content such that a user device associated with the second user is configured to retrieve the distributed content from the one or more nodes.

13. The computing system of claim 10, wherein the processor is further configured to execute the computer-executable instructions to:
identify that the predetermined parameter is satisfied; and
transmit, to the one or more nodes, a second request associated with the identification of the predetermined parameter being satisfied.

14. The computing system of claim 10, wherein the processor is further configured to execute the computer-executable instructions to:
associate the permission list with a third transaction between the first user and a third user such that the second layer is associated with the third user; and
transmit, to the one or more nodes, a second request associated with the third transaction.

15. The computing system of claim 10, wherein the processor is further configured to execute the computer-executable instructions to receive, from the one or more nodes, a third notification associated with a third validation, the third validation associated with a third transaction regarding the distributed content between the second user and a third user.

16. One or more computer storage media embodied with computer-executable instructions, the one or more computer storage media comprising:
a client component that, upon execution by at least one processor, receives a first transaction request associated with a first transfer of an asset between a first user and a second user, and transmits a response to the first transaction request;
a consensus component that, upon execution by the at least one processor, transmits a local instance of the first transaction request to one or more nodes in a network, receives one or more remote instances of the first transaction request from the one or more nodes in the network, and implements a consensus protocol to validate a transaction associated with the first transfer of the asset;
a manager component that, upon execution by the at least one processor, associates a first permission layer with the first user such that the first user is associated with a first set of privileges, and associates a second permission layer with the second user such that the second user is associated with a second set of privileges; and
a trigger component that, upon execution by the at least one processor, monitors one or more of the asset, the first user, or the second user and, responsive to a triggering event being detected, determines whether a second transfer of the asset between the first user and the second user is to be performed for modifying the second permission layer.

17. The one or more computer storage media of claim 16, wherein the client component is configured to transmit an instruction to perform the second transfer of the asset.

18. The one or more computer storage media of claim 16, wherein the client component is configured to receive a content request, and the manager component is configured to analyze the content request to determine whether the content request is in accordance with one or more of the first set of privileges or the second set of privileges.

19. The one or more computer storage media of claim 16, wherein the client component is configured to receive a second transaction request associated with a second transfer of the asset, and the manager component is configured to analyze the second transaction request to determine whether the second transaction request is in accordance with one or more of the first set of privileges or the second set of privileges.

20. The one or more computer storage media of claim 16, wherein the trigger component is configured to evaluate one or more of a time-based predetermined condition, a proximity-based predetermined condition, a capital resource-based predetermined condition, a privilege-based predetermined condition, or an event-based predetermined condition.
